(19) United States
(12) Patent Application Publication
(10) Pub. No.: US 2008/0113290 A1
(43) Pub. Date: May 15, 2008

(54) Method of preparing toner, toner prepared using the method, method of forming image using the toner, and image forming apparatus employing the toner

(75) Inventors: Min-young Cheong, Seoul (KR); Chang-kook Hong, Suwon-si (KR); Yo-da Shin, Incheon (KR); Jeong-won Lee, Seoul (KR); Kyung-yol Yon, Seongnam-si (KR); Sang-soon Lim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/984,231

(22) Filed: Nov. 15, 2007

(30) Foreign Application Priority Data
Nov. 15, 2006 (KR) 2006-113046

(51) Int. Cl. G03G 9/087; G03G 15/08

(52) U.S. Cl. 430/109.31; 399/253; 430/109.3; 430/125.3; 430/137.15

(57) ABSTRACT

A method of preparing toner includes preparing a pigment dispersion solution by dispersing a pigment in a mixed surfactant solution composed of an anionic reactive surfactant and a nonionic reactive surfactant, mixing the pigment dispersion solution with a polymer latex prepared by polymerizing a toner composition comprising an amphiphilic macromonomer having at least one reactive functional group at an end thereof and at least one polymerizable monomer, and adding an inorganic salt to a mixed solution of the polymer latex and the pigment dispersion solution to be agglomerated, wherein a shape of toner particles can be controlled to have circularity of 0.5-1.0 by adjusting an amount of the nonionic reactive surfactant to be 20-100 parts by weight based on 100 parts by weight of the anionic reactive surfactant. In addition, a method of forming an image uses the toner, and an image forming apparatus to form an image employs the toner.

### CROSS-REFERENCE TO RELATED APPLICATIONS

This application claims the benefit of Korean Patent Application No. 10-2006-0113046, filed on Nov. 15, 2006, in the Korean Intellectual Property Office, the disclosure of which is incorporated herein in its entirety by reference.

### BACKGROUND OF THE INVENTION

1. Field of the Invention

The present general inventive concept relates to a method of preparing toner and toner prepared using the method, and more particularly, to a method of preparing toner using a pigment dispersion solution prepared by dispersing a pigment in a mixed surfactant solution composed of an anionic reactive surfactant and a nonionic reactive surfactant, toner prepared using the method, a method of forming an image using the toner and an image forming apparatus employing the toner.

2. Description of the Related Art

In an electrophotographic process or an electrostatic recording process, a developer is used to shape an electrostatic image or an electrostatic latent image and may be a two-component developer formed of toner and carrier particles or a one-component developer formed of toner only. The one-component developer may be a magnetic one-component developer or a nonmagnetic one-component developer. Fluiding agents, such as colloidal silica, are often added independently into the nonmagnetic one-component developer to increase the flowability of the toner. Generally, coloring particles obtained by dispersing a pigment, such as carbon black, or other additives in a binding resin are used in the toner.

Methods of preparing toner include pulverization or polymerization. In pulverization, toner is obtained by melting and mixing synthetic resins with pigments and, if needed, other additives, pulverizing the mixture and sorting the particles until particles of a desired size are obtained. In polymerization, a polymerizable monomer composition is manufactured by uniformly dissolving or dispersing a polymerizable monomer, a pigment, a polymerization initiator and, if needed, various additives such as a cross-linking agent and an antistatic agent. Next, the polymerizable monomer composition is dispersed in an aqueous dispersive medium which includes a dispersion stabilizer using an agitator to shape minute liquid droplet particles. Subsequently, the temperature is increased and suspension polymerization is performed to obtain polymerized toner having coloring polymer particles of a desired size.

In an image forming device such as an electrophotographic device or an electrostatographic recording device, an image is formed by exposing an image on a uniformly charged photoreceptor to form an electrostatic latent image, attaching toner to the electrostatic latent image to form a toned image, transferring the toned image onto a transfer member such as transfer paper or the like, and then fixing the unfixed toned image on the transfer member by means of various methods, including heating, pressurizing, solvent steaming and the like. In most fixing processes, the transfer medium with the toner image passes through fixing rollers and pressing rollers, and by heating and pressing, the toner image is fused to the transfer medium.

Images formed by an image forming apparatus such as an electrophotocopier should satisfy requirements of high precision and accuracy. Conventionally, toner used in an image forming apparatus is usually obtained using pulverization. In pulverization, color particles having a large range of sizes are formed. Hence, to obtain satisfactory developer properties, there is a need to sort the coloring particles obtained through pulverization according to size to reduce the particle size distribution. However, it is difficult to precisely control the particle size distribution using a conventional mixing/pulverizing process in the manufacture of toner particles suitable for an electrophotographic process or an electrostatic recording process. Also, when preparing fine particle toner, the toner preparation yield is low due to a sorting process. In addition, there is a limit to a change/adjustment of a toner design for obtaining desirable charging and fixing properties. Accordingly, polymerized toners, the size of particles of which is easy to control and which do not need to undergo a complex manufacturing process such as sorting, have been highlighted recently.

When toner is prepared through polymerization, polymerized toner with a desired particle diameter and diameter distribution can be obtained without pulverizing or sorting.

U.S. Pat. No. 6,033,822 discloses a conventional polymerized toner. The conventional polymerized toner includes core particles and shells covering the core particles and is prepared by suspension polymerization. However, it is still difficult to control the shape and size of the toner particles using such a method, and moreover, the toner particle size distribution is wide.

U.S. Pat. No. 6,258,911 discloses bifunctinoal macromolecules and toner compositions formed of the macromolecules. The toner compositions include a narrow polydispersity and a method of emulsification-aggregation polymerization for preparing polymer having free radicals that are covalently-bonded at both ends of the polymer. However, in spite of using this method, a surfactant could result in reverse effects and it was still difficult to control the size of the latex particles.

### SUMMARY OF THE INVENTION

The present general inventive concept provides a method of preparing toner for a high-speed printer with high image quality in which fixation of toner particles to paper at a low temperature is possible and excellent durability and storage are obtained by easily adjusting the shape of the toner particles.

The present general inventive concept also provides toner in which a shape of toner particles can be easily controlled, and physical properties of the toner, such as storage, durability, etc., are excellent.

The present general inventive concept also provides a method of forming high quality images in which fixation of toner particles to a printing medium, such as a sheet of paper, is possible using the toner in which the shape of the toner particles can be easily controlled, and physical properties of the toner such as storage, durability, etc. are excellent.

The present general inventive concept also provides an apparatus to form high quality images in which fixation of toner particles to a printing medium, such as a sheet of paper, is possible, including the toner in which the shape of the toner particles can be easily controlled, and physical properties of the toner such as storage, durability, etc. are excellent.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of preparing toner including preparing a pigment dispersion solution by dispersing a pigment in a mixed surfactant solution composed of an anionic reactive surfactant and a nonionic reactive surfactant, mixing the pigment dispersion solution with a polymer latex prepared by polymerizing a toner composition comprising an amphiphilic macromonomer having at least one reactive functional group at an end thereof and at least one polymerizable monomer, and adding an inorganic salt to a mixed solution of the polymer latex and the pigment dispersion solution to be aggregated, wherein a shape of toner particles of the toner can be controlled to have circularity of 0.5-1.0 by adjusting an amount of the nonionic reactive surfactant to be 20-100 parts by weight based on 100 parts by weight of the anionic reactive surfactant.

The foregoing and/or other aspects and utilities of the present general inventive concept may also be achieved by providing a developing unit containing toner prepared using a method comprising including preparing a pigment dispersion solution by dispersing a pigment in a mixed surfactant solution composed of an anionic reactive surfactant and a nonionic reactive surfactant, mixing the pigment dispersion solution with a polymer latex prepared by polymerizing a toner composition comprising an amphiphilic macromonomer having at least one reactive functional group at an end thereof and at least one polymerizable monomer, and adding an inorganic salt to a mixed solution of the polymer latex and the pigment dispersion solution to be agglomerated, wherein particles of the toner can have circularity of 0.5-1.0 by adjusting the amount of the nonionic reactive surfactant to be 20-100 parts by weight based on 100 parts by weight of the anionic reactive surfactant

The foregoing and/or other aspects and utilities of the present general inventive concept may also be achieved by providing toner prepared using a method including preparing a pigment dispersion solution by dispersing a pigment in a mixed surfactant solution composed of an anionic reactive surfactant and a nonionic reactive surfactant, mixing the pigment dispersion solution with a polymer latex prepared by polymerizing a toner composition comprising an amphiphilic macromonomer having at least one reactive functional group at an end thereof and at least one polymerizable monomer, and adding an inorganic salt to a mixed solution of the polymer latex and the pigment dispersion solution to be agglomerated, wherein particles of the toner can have circularity of 0.5-1.0 by adjusting the amount of the nonionic reactive surfactant to be 20-100 parts by weight based on 100 parts by weight of the anionic reactive surfactant.

The foregoing and/or other aspects and utilities of the present general inventive concept may also be achieved by providing a method of forming an image using the toner prepared using the above-described method, wherein the method includes attaching the toner to the surface of a photoreceptor on which an electrostatic latent image is formed to form a visualized image and transferring the visualized image to a transfer medium.

The foregoing and/or other aspects and utilities of the present general inventive concept may also be achieved by providing an image forming apparatus including an organic photoreceptor, an image forming unit that forms an electrostatic latent image on a surface of the organic photoreceptor, an unit to receive the toner prepared using the above-described method, a toner supplying unit that supplies the toner onto the surface of the organic photoreceptor in order to form a toner image by developing the electrostatic latent image, and a toner transferring unit that transfers the toner image to a transfer medium from the surface of the organic photoreceptor.

### BRIEF DESCRIPTION OF THE DRAWINGS

The above and other aspects and utilities of the present general inventive concept will become more apparent by describing in detail exemplary embodiments thereof with reference to the attached drawings in which:

FIG. 1 illustrates an image forming apparatus according to an embodiment of the present general inventive concept;

FIG. 2 is a scanning electron microscope (SEM) image of toner prepared according to Example 1;

FIG. 3 is a SEM image of toner prepared according to Example 2;

FIG. 4 is a SEM image of toner prepared according to Example 3;

FIG. 5 is a SEM image of toner prepared according to Example 4;

FIG. 6 is a SEM image of toner prepared according to Example 5;

FIG. 7 is a SEM image of toner prepared according to Comparative Example 1;

FIG. 8 is a SEM image of toner prepared according to Comparative Example 2; and

FIG. 9 is a SEM image of toner prepared according to Comparative Example 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The present general inventive concept provides a method of preparing toner, the method including preparing a pigment dispersion solution by dispersing a pigment in a mixed surfactant solution composed of an anionic reactive surfactant and a nonionic reactive surfactant, mixing the pigment dispersion solution with a polymer latex prepared by polymerizing a toner composition comprising an amphiphilic macromonomer having at least one reactive functional group at an end thereof and at least one polymerizable monomer, and adding an inorganic salt to a mixed solution of the polymer latex and the pigment dispersion solution to be agglomerated, wherein the shape of toner particles can be controlled to have circularity of 0.5-1.0 by adjusting the amount of the nonionic reactive surfactant to be 20-100 parts by weight based on 100 parts by weight of the anionic reactive surfactant.

In the method of preparing toner according to the present general inventive concept, the shape of particles of toner to be prepared can be controlled by adjusting a weight ratio of the anionic reactive surfactant and the nonionic reactive surfactant.

That is, when the nonionic reactive surfactant is used in the preparation of the pigment dispersion solution, toner particles having a uniform shape can be obtained by accelerating aggregation within a constant aggregation time compared with when the anionic reactive surfactant is used alone. In addition, as a larger amount of the nonionic reactive surfactant is used, a toner particle forming time or a time to form a desired shape or size of toner particles is longer in a constant aggregation time. As a result, the shape of the toner particles becomes nearly spherical s. Therefore, the shape of the toner particles can be controlled according to a weight ratio of the anionic reactive surfactant to the nonionic reactive surfactant. The shape of the toner particles can be represented in terms of a circularity value.

In particular, the toner particles may have circularity of 0.5-1.0 when the amount of the nonionic reactive surfactant is 20-100 parts by weight based on 100 parts by weight of the anionic reactive surfactant, thereby becoming nearly spherical.

The anionic reactive surfactant and the nonionic reactive surfactant may be used by adjusting a weight ratio thereof according to a type of a pigment, and thus the degree of aggregation can be adjusted. For example, black and cyan can be fairly aggregated, and magenta and yellow are not relatively aggregated. Therefore, the larger the amount of the nonionic reactive surfactant with respect to black and cyan, the better aggregation can be.

The pigment dispersion solution can be prepared by mixing a pigment with deionized water, an anionic reactive emulsifying agent and a nonionic reactive emulsifying agent and dispersing the mixture using a homogenizer. Here, various methods can be used.

For example, the pigment dispersion solution can be prepared by dispersing a pigment in the anionic reactive surfactant and the nonionic reactive surfactant, respectively and then mixing the anionic reactive surfactant comprising the pigment dispersed therein and the nonionic reactive surfactant comprising the pigment dispersed therein. The pigment dispersion solution can also be prepared by mixing the anionic reactive surfactant and the nonionic reactive surfactant and then dispersing a pigment in the mixed reactive surfactant.

The pigment dispersion solution can have an amount of 10-30 parts by weight of a pigment based on 100 parts by weight of a mixed surfactant solution. When the amount of the pigment is less than 10 parts by weight, the pigment amount in a final toner is insufficient. On the other hand, when the amount of the pigment is greater than 30 parts by weight, the aggregation is not uniform.

The anionic reactive surfactant can be rosin acid soap, sodium dodecyl sulfate, sodium lauryl sulfate, sodium oleate, potassium oleate, sodium dodecyl benzene sulfonate, sodium dodecyl allyl sulfosuccinate, disodium ethoxylated alcohol half ester of sulfosuccinis acid, sodium dioctyl sulfosuccinate, proprietary sulfosuccinate blend or the like, but is not limited thereto.

The nonionic reactive surfactant can be alkyl polyethoxy acrylate, alkyl polyethoxy methacrylate, aryl polyethoxy acrylate, aryl polyethoxy methacrylate or the like, but is not limited thereto.

In addition, in the method of preparing toner according to the present invention, a polymer latex is formed by polymerizing a toner composition comprising an amphiphilic macromonomer having at least one reactive functional group at an end thereof and at least one polymerizable monomer. The pigment dispersion solution prepared using the method described above is added to the polymer latex and an inorganic salt is added thereto. An aggregation reaction occurs by the added inorganic salt, and the size and shape of the toner particles can be controlled. After the desired size and shape of the polymer latex particles are obtained, the resultant is filtered to separate toner particles and dry them. The dried toner is externally treated using silica or the like to adjust the amount of electric charge. As a result, a final toner is obtained.

The macromonomer used herein is an amphiphilic material having both a hydrophilic group and a hydrophobic group, and is in the shape of a polymer or an oligomer having at least one reactive functional group at an end thereof. The hydrophilic group of the macromonomer which is chemically combined on the surface of the polymer latex particles may increase the long-term stability of the toner particles by steric stabilization, and can adjust the size of the polymer latex particles according to the amount or molecular weight of the injected macromonomer. The hydrophobic group of the macromonomer exists on the surface of the toner particles and can facilitate polymerization reaction. Macromonomers can shape copolymers by being bonded with polymerizable monomers contained in a toner composition by grafting, branching, or cross-linking. The polymer latex can simplify processes of preparing the toner and reduce preparation cost of polymerizable toner.

The weight average molecular weight of the amphiphilic macromonomers may be 100 to 100,000, preferably 1,000 to 10,000. When the weight average molecular weight of the amphiphillic macromonomers is less than 100, the physical properties of the toner are not improved or the toner cannot function efficiently as a stabilizer. When the weight average molecular weight of the macromonomers is greater than 100,000, the reaction conversion rate may be lowered.

The amphiphilic macromonomer may be a material selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate, but is not limited thereto.

The polymerizable monomer can be selected from vinyl monomer, polar monomer having a carboxyl group, a monomer having an unsaturated polyester group, and a monomer having a fatty acid group.

The polymerizable monomer is at least one selected from the group consisting of styrene monomers such as styrene, vinyl toluene, α-methyl styrene; acrylic acid, methacrylic acid; derivatives of (meth)acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, metacryl amide; ethylenically unsaturated monoolefins such as ethylene, propylene, butylenes; halogenized vinyls such as vinyl chloride, vinylidene chloride, vinyl fluoride; vinyl esters such as vinyl acetate, vinyl propionate; vinyl ethers such as vinyl methyl ether, vinyl ethyl ether; vinyl ketones such as vinyl methyl ketone, methyl isoprophenyl ketone; and nitrogen-containing vinyl compounds such as 2-vinylpyridine, 4-vinylpyridine, N-vinyl pyrrolidone, but is not limited thereto.

The toner composition has an amount of 1-10 parts by weight of the amphiphilic macromonomer based on 100 parts by weight of the polymerizable monomer, and preferably 3-7 parts by weight.

When the amount of the amphiphilic macromonomer is less than 1 part by weight, the dispersion stability of toner particles can be reduced. On the other hand, when the amount of the amphiphilic macromonomer is greater than 10 parts by weight, physical properties of toner can deteriorate.

The toner prepared using the method may further include an initiator and a chain transfer agent.

The radicals created by the initiator may react with the polymerizable monomer. The radicals can react with reactive functional groups of the macromonomers and shape copolymers.

Examples of the initiator may include persulfate salts such as potassium persulfate, ammonium persulfate, etc.; azo compounds such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1,1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile) etc.; peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, di-t-butylperoxy isophthalate, etc. Also, an oxidization-reduction initiator in which the polymerization initiator and a reduction agent are combined may be used.

A chain transfer agent defines a material that converts a type of a chain carrier in a chain reaction. A new chain has much less activity than that of a previous chain. The chain transfer agent can reduce polymerization of monomers and initiates a new chain. Using the chain transfer agent, the polymerization degree of the monomer can be reduced and new chains can be initiated. In addition, a molecular weight distribution of the polymer latex can be adjusted. Examples of the chain transfer agent include sulfur containing compounds such as dodecanthiol, thioglycolic acid, thioacetic acid, and mercaptoethanol; phosphorous acid compounds such as phosphorous acid and phosphorous natrium; hypophosphorous acid compounds such as hypophosphorous acid and hypophosphorous natrium; and alcohols such as methyl alcohol, ethyl alcohol, isopropyl alcohol, and n-butyl alcohol, but are not limited thereto.

In addition, the toner is prepared by adding an inorganic salt to a mixed solution of a polymer latex and a pigment dispersion solution to generate aggregation. That is, ionic strength that is increased by the addition of the inorganic salt reduces the dispersion stability of toner particles, thereby facilitating aggregation between toner particles. Accordingly, the size of the toner particles increases.

When a concentration of the inorganic salt is heavier than a critical coagulation concentration (CCC), an electrostatic repulsive force between polymer latex particles may be offset, and thus aggregation may rapidly occur due to Brownian motion of the polymer latex particles. When a concentration of the inorganic salt is lower than the CCC, an aggregation speed may be slow, and thus aggregation of polymer latex particles can be controlled. Here, examples of the inorganic salt may include at least one selected from the group consisting of NaCl, MgCl₂.8H₂O, and [Al₂(OH)ₙCl₆₋ₙ]ₘ where 1≦n≦5, 1≦m≦10, but are not limited thereto.

A process of preparing a polymerization toner according to an embodiment of the present general inventive concept will be described as follows.

While the inside of a reactor is purged with nitrogen gas, a medium such as a distilled deionized water (or a mixture of water and an organic solvent), etc. and a mixing solution of amphiphilic macromonomers are added to the reactor, and heated while stirring. At this time, an electrolyte such as NaCl or an ionic salt, etc. can be added to adjust ion strength of the reacting medium. When the temperature inside the reactor reaches a certain level, an initiator, preferably a water-soluble free radical initiator, is injected. Subsequently, at least one polymerizable monomer is injected into the reactor using a semi-continual method with a chain transfer agent, preferably. Here, polymerizable monomers are slowly provided using a starved feeding process to adjust a reaction speed and dispersibility of the solution.

Amphiphilic macromonomers can function not only as a copolymer but also as a stabilizer. Initial reaction of radicals and monomers creates oligomer radicals and shows an in-situ stabilization effect. An initiator dissolved by heat creates radicals and reacts with a monomer in an aqueous solution and the hydrophobicity of the solution increases. Such hydrophobicity of oligomer radicals facilitates diffusion into micelle and reaction with polymerizable monomers, and together with this, a copolymerization reaction with macromonomers can be processed.

Due to the hydrophilicity of the amphiphilic macromonomers, copolymerization can easily occur in the vicinity of the surface of the toner particles. The hydrophilic portions of the macromonomers located on the surface of the toner particles increase the stability of the toner particles by steric stabilization, and the size of the toner particles can be adjusted according to the amount or molecular weight of the macromonomers. Also, functional groups reacting on the surface of the toner particles can improve the frictional electricity of the toner.

The toner further includes at least one of a pigment and a wax.

The pigment can be selected from the group consisting of yellow, magenta, cyan and black pigment. In particular, the pigment can be carbon black or aniline black in the case of black toner. A nonmagnetic toner is efficient for preparing color toner. For color toner, carbon black is used as a black colorant, and yellow, magenta, and cyan pigments are further included for colored colorants.

For the yellow pigment, a condensation nitrogen compound, an isoindolinone compound, anthraquinone compound, an azo metal complex, or an allyl imide compound can be used. In detail, C.I. pigment yellow 12, 13, 14, 17, 62, 74, 83, 93, 94, 95, 109, 110, 111, 128, 129, 147, 168, 180, or the like can be used.

For the magenta pigment, a condensation nitrogen compound, an anthraquinone, quinacridone compound, base dye lake compound, naphthol compound, benzo imidazole compound, thioindigo compound, or perylene compound can be used. In detail, C.I. pigment red 2, 3, 5, 6, 7, 23, 48:2, 48:3, 48:4, 57:1, 81:1, 122, 144, 146, 166, 169, 177, 184, 185, 202, 206, 220, 221, 254, or the like can be used.

For the cyan pigment, copper phthlaocyanine compound and derivatives thereof, anthraquinone compound, or base dye lake compound can be used. In detail, C.I. pigment blue 1, 7, 15, 15:1, 15:2, 15:3, 15:4, 60, 62, 66, or the like can be used.

Such colorants can be used alone or in a combination of at least two colorants, and are selected in consideration of color, chromacity, luminance, resistance to weather, dispersion property in toner, etc.

The amount of the pigment as described above is preferably 0.1 to 20 parts by weight, based on 100 parts by weight of the polymerizable monomer. The amount of the pigment should be sufficient to color the toner; however, when the amount of the pigment is less than 0.1 parts by weight based on 100 parts by weight of the polymerizable monomer, the coloring effect is not sufficient. When the amount of the pigment is greater than 20 parts by weight, the preparation costs of the toner increases, and thus sufficient frictional charge cannot be obtained.

The wax may be appropriately selected according to the purpose of the final toner. Examples of the wax that can be used include polyethylene-based wax, polypropylene-based wax, silicone wax, paraffin-based wax, ester-based wax, carbauna wax and, metallocene wax, but are not limited thereto. The melting point of the wax is preferably about 50-150° C. Wax constituents are physically attached to the toner particles, but are preferably not covalently bonded with toner particles. Thus, a toner that is fixed at a low fixing temperature on a final image receptor and shows excellent final image durability and resistance to abrasion is provided.

The toner may further include at least one selected from a release agent and a charge control agent.

The release agent can be used to protect a photoreceptor and prevent deterioration of developing, thereby obtaining a high quality image. A release agent may be a high purity solid fatty acid ester material. Examples of the release agent include low molecular weight polyolefins such as low molecular weight polyethylene, low molecular weight polypropylene, low molecular weight polybutylenes, etc.; paraffin wax; multi-functional ester compound, etc. The release agent used in the present invention may be a multifunctional ester compound composed of alcohol having three functional groups or more and carboxylic acid.

The polyhydric alcohol with at least three functional groups may be an aliphatic alcohol, such as glycerin, pentaerythritol, pentaglycerol, or the like; an alicyclic alcohol, such as chloroglycitol, quersitol, inositol, or the like; an aromatic alcohol, such as tris(hydroxymethyl)benzene, or the like; a sugar, such as D-erythrose, L-arabinose, D-mannose, D-galactose, D-fructose, L-lmunose, sucrose, maltose, lactose, or the like; or a sugar-alcohol, such as erythrite, D-trate, L-arabite, adnit, chissirite, or the like.

The carboxylic acid may be an aliphatic carboxylic acid, such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid, tetrolic acid, or the like; an alicyclic carboxylic acid, such as cyclohexanecarboxylic acid, hexahydroisophthalic acid, hexahydroterephthalic acid, 3,4,5,6-tetrahydrophthalic acid, or the like; or an aromatic carboxylic acid, such as benzoic acid, cumic acid, phthalic acid, isophthalic acid, terephthalic acid, trimeth acid, trimellitic acid, hemimellitic acid, or the like.

The charge control agent may be preferably selected from the group consisting of a salicylic acid compound containing metals such as zinc, aluminium, boron complexes of bis diphenyl glycolic acid, and silicate. More preferably, dialkyl salicylic acid zinc, boro bis(1,1-diphenyl-1-oxo-acetyl potassium salt), etc. can be used.

The present invention also provides a toner prepared by preparing a pigment dispersion solution by dispersing a pigment in a mixed surfactant solution composed of an anionic reactive surfactant and a nonionic reactive surfactant; mixing the pigment dispersion solution with a polymer latex prepared by polymerizing a toner composition comprising an amphiphilic macromonomer having at least one reactive functional group at an end thereof and at least one polymerizable monomer; and adding an inorganic salt to a mixed solution of the polymer latex and the pigment dispersion solution to be agglomerated, wherein particles of the toner can have circularity of 0.5-1.0 by adjusting the amount of the nonionic reactive surfactant to be 20-100 parts by weight based on 100 parts by weight of the anionic reactive surfactant.

Particles of the toner prepared using the method of preparing toner according to the current embodiment of the present general inventive concept may have a volume average diameter of 0.5-20 μm, and preferably 5-10 μm.

The present embodiment also provides a method of forming an image using the toner of the present invention, the method including attaching the toner to the surface of a photoreceptor on which an electrostatic latent image is formed to form a visualized image and transferring the visualized image to a transfer medium. In the method of forming an image using the toner of the present general inventive concept, the toner is prepared by preparing a pigment dispersion solution by dispersing a pigment in a mixed surfactant solution composed of an anionic reactive surfactant and a nonionic reactive surfactant, mixing the pigment dispersion solution with a polymer latex prepared by polymerizing a toner composition comprising an amphiphilic macromonomer having at least one reactive functional group at an end thereof and at least one polymerizable monomer and adding an inorganic salt to a mixed solution of the polymer latex and the pigment dispersion solution to be aggregated. In addition, the shape of toner particles can have circularity of 0.5-1.0 by adjusting the amount of the nonionic reactive surfactant to be 20-100 parts by weight based on 100 parts by weight of the anionic reactive surfactant.

A representative electrophotographic image forming process includes charging, exposure to light, developing, transferring, fixing, cleaning, and antistatic process operations, and a series of processes of forming images on a receptor.

In the charging process, a surface of a photoreceptor is charged with negative or positive charges, whichever is desired, by a corona or a charge roller. In the light exposing process, an optical system, conventionally a laser scanner or an array of diodes, selectively discharges the charged surface of the photoreceptor in an imagewise manner corresponding to a final visual image formed on a final image receptor to shape a latent image. Electromagnetic radiation that can be referred to as “light” includes infrared radiation, visible light, and ultraviolet radiation.

In the developing process, appropriate polar toner particles generally contact the latent image of the photoreceptor, and conventionally, an electrically-biased developer having identical potential polarity to the toner polarity is used. The toner particles move to the photoreceptor and are selectively attached to the latent image by electrostatic electricity, and shape a toner image on the photoreceptor.

In the transferring process, the toner image is transferred to the final image receptor from the photoreceptor, and sometimes, an intermediate transferring element is used when transferring the toner image from the photoreceptor to aid the transfer of the toner image to the final image receptor.

In the fixing process, the toner image of the final image receptor is heated and the toner particles thereof are softened or melted, thereby fixing the toner image to the final image receptor. Another way of fixing is to fix toner on the final image receptor under high pressure with or without the application of heat.

In the cleaning process, remaining toner on the photoreceptor is removed. Finally, in the antistatic process, charges of a medium/body of the photoreceptor are exposed to light of a predetermined wavelength band and are reduced to a substantially uniform, low value, and thus the residue of the original latent image is removed, and the photoreceptor is prepared for a next image forming cycle.

The present invention also provides an image forming apparatus including: an organic photoreceptor; a unit for charging the surface of the organic photoreceptor; an image forming unit that forms an electrostatic latent image on the surface of the organic photoreceptor; a unit for receiving the toner; a toner supplying unit that supplies the toner onto the surface of the organic photoreceptor in order to form a toner image by developing the electrostatic latent image; and a toner transferring unit that transfers the toner image to a transfer medium from the surface of the organic photoreceptor. In the image forming apparatus according to the present invention, the toner is prepared using a method comprising: forming a polymer latex by polymerizing a toner composition comprising a macromonomer containing a hydrophilic group, a hydrophobic group and at least one reactive functional group, at least one polymerizable monomer, an initiator and a chain transfer agent; mixing the polymer latex with a pigment dispersion solution that is dispersed in an anionic reactive surfactant and a nonionic reactive surfactant; adding an inorganic salt to the mixture in order for toner to be agglomerated; and separating and drying the agglomerated toner.

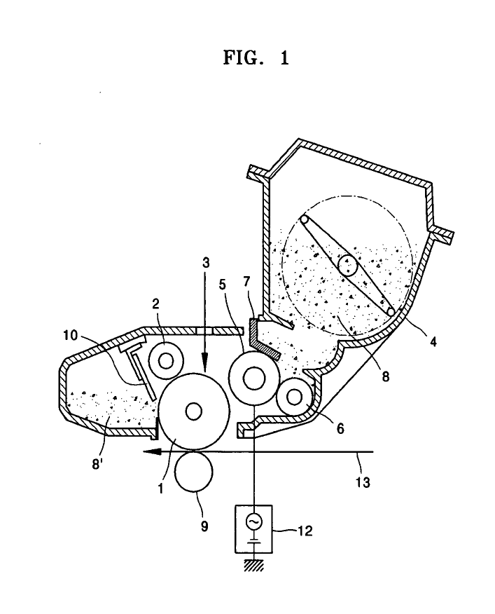

FIG. 1 is a schematic diagram of a non-contact developing type image forming apparatus using a toner prepared using the method according to an embodiment of the present invention. The operating principles of the image forming apparatus are explained below.

A developer 8, which is a nonmagnetic one-component developer of a developing unit 4, is supplied to a developing roller 5 through a feeding roller 6 formed of an elastic material such as a polyurethane foam or sponge. The developer 8 supplied to the developing roller 5 reaches a contact point between the developing roller 5 and a developer regulation blade 7 as the developing roller 5 rotates. The developer regulation blade 7 is formed of an elastic material such as metal, rubber, or the like. When the developer 8 passes the contact point between the developing roller 5 and the developer regulation blade 7, the developer 8 is smoothed to form a thin layer that is sufficiently charged. The developing roller 5 transfers the thin layer of the developer 8 to a developing domain where the thin layer of the developer 8 is developed on the electrostatic latent image of a photoreceptor 1, which is a latent image carrier. The electrostatic latent image is formed by scanning light 3 to the photoreceptor 1.

The developing roller 5 and the photoreceptor 1 face each other with a constant distance therebetween. The developing roller 5 rotates counterclockwise and the photoreceptor 1 rotates clockwise.

The developer 8 transferred to the developing domain of the photoreceptor 1 forms an electrostatic latent image on the photoreceptor 1 according to the intensity of an electric charge generated due to a difference between an AC voltage superposed with a DC voltage applied from a power supply 12 to the developing roller 5 and a latent image potential of the photoreceptor 1 that is charged by a charging unit 2. Accordingly, a toner image is formed.

The developer 8 developed on the photoreceptor 1 is transferred to a transferring device 9 as the photoreceptor 1 rotates. A high voltage with an opposite polarity to the developer 8 is applied to the transferring device 9, and thus an image is formed on the transferring device 9. The developer 8 developed on the photoreceptor 1 is transferred to a sheet of paper 13, and as the paper 13 passes through the developer 8 developed on the photoreceptor 1 as corona discharge or as a roller by a transfer unit 9 to which a high voltage having inverse polarity with respect to the developer 8 is applied, thus forming an image.

The image transferred to the printing paper 13 passes through a fusing device (not shown) that provides high temperature and high pressure, and the image is fused to the printing paper 13 as the developer 8 is fused to the printing paper 13. Meanwhile, the developer 8 remaining on the developing roller 5 and which is not developed is transferred back to the feeding roller 6 contacting the developing roller 5. A remaining developer 8′ that is undeveloped on the photoreceptor 1 is collected by a cleaning blade 10.

The above processes are repeated.

The present invention will be described in more detail with reference to the examples below, but is not limited thereto. The following examples are for illustrative purposes only and are not intended to limit the scope of the invention.

### EXAMPLES

### Synthesis of Polymer Latex

While the inside of a 1 L reactor was purged with nitrogen gas, a mixed solution of 420 g of distilled deionized water and 3.5 g of poly(ethylene glycol)ethyl ether methacrylate (PEG-EEM, Aldrich) was added to the reactor, agitated at 250 rpm and heated at the same time. When the inner temperature of the reactor reached 82° C., 1.9 g of potassium persulfate (KPS) was dissolved in 45 g of deionized water and inputted into the reactor as a reaction initiator, and 87 g of a monomer mixture of styrene, butyl acrylate, and metacrylic acid (weight ratio of 100:28:2) and 1.3 g of 1-dodecanethiol, which is a chain transfer agent, were added to the reactor using a starved-feeding method.

During the reaction, 13.5 g of ester wax was heated in a mixed solution comprising 25.3 g of a monomer mixture of styrene, butyl acrylate, and metacrylic acid (here, a weight ratio of 100:28:2) and 0.4 g of 1-dodecanthiol and melted slowly, and dispersed in a mixed solution comprising 1,100 g of distilled water and 1.0 g of a macromonomer (HS-10, DAI-ICHI KOGYO) with the same ratio of the initial reaction to prepare a wax dispersion solution. The prepared wax dispersion solution was put into the reactor, and 1 g of KPS was dissolved in 36 g of deionized water and the resultant was added to the reactor. The reaction time took 2-3 hours, and when the reaction was finished, 1.6 g of KPS was dissolved in 50 g of deionized water and the resultant was added to the reactor. Then, 73 g of a monomer mixture of styrene, butyl acrylate, and metacrylic acid (in a weight ratio of 100:28:2) and 1.1 g of 1-dodecanthiol, which was a chain transfer again, were put into the reactor, reacted for about 4 hours and then cooled naturally. After the reaction, the size of the polymer latex particles was 400-600 nm, and the conversion rate was near 100%.

Preparation of Pigment Dispersion Solution

10 g of a solution prepared by mixing an anionic reactive surfactant (HS-10; DAI-ICH KOGYO) and a nonionic reactive surfactant (RN-10; DAI-ICH KOGYO) according to a mixing ratio shown in Table 1 below, and 60 g of a pigment (Black, Cyan, Magenta or Yellow) were added to 250 g of ultra pure water and then dispersed using a homogenizer. An ultrasonic homogenizer, a bead miller that uses 400 g of a glass bead having a diameter of 0.8-1 mm, or a micro fluidizer was used as a homogenizer.

TABLE 1
Mixing ratio of pigment dispersion solution

| | HS-10:RN-10 | | |
|---|---|---|---|
| | (part by weight:part | Pigment | |
| Conditions | by weight) | color | Pigment type |
| Example 1 | 100:25 | black | Mogul-L |
| Example 2 | 100:100 | yellow | PY-74 |
| Example 3 | 100:100 | magenta | PR-122 |
| Example 4 | 100:25 | cyan | PB 15:4 |
| Example 5 | 100:43 | cyan | PB 15:4 |
| Comparative Example 1 | SDS | cyan | PB 15:4 |
| Comparative Example 2 | HS-10 alone | black | Mogul-L |
| Comparative Example 3 | HS-10 alone | cyan | PB 15:4 |
| Comparative Example 4 | HS-10 alone | magenta | PR-122 |
| Comparative Example 5 | HS-10 alone | yellow | PY-74 |
| Comparative Example 6 | RN-10 alone | black | Mogul-L |
| Comparative Example 7 | RN-10 alone | yellow | PY-74 |
| Comparative Example 8 | RN-10 alone | magenta | PR-122 |

Aggregation and Preparation of Toner

316 g of deionized water and 307 g of a copolymer latex composed of copolymers of styrene, butyl acrylate, methacrylic acid and poly(ethylene glycol) ethyl ether methacrylate with different molecular weights, and containing waxes, which was obtained from the previous polymerization process, were introduced into a 1-L reactor, and the mixture was stirred at 350 rpm. While the mixture was agitated, 30 g of a mixed pigment solution dispersed by a reactive surfactant was added to the reactor. The pH of the mixture was adjusted to be 11, and then MgCl₂.8H₂O, which was an inorganic salt, was added dropwize to the mixture and the mixture was heated up to 95 [symbol] . After the mixture was reacted at 95 [symbol] for 2-4 hours, NaCl was added to the mixture. Then, the reaction was performed until a desired size and shape of the resultant were obtained. Thereafter, the temperature of the resultant was cooled to less than room temperature, and the resultant was filtered to separate toner particles and to dry them. The dried toner particles were subjected to a surface treatment using silica or the like and the charged electric charge amount thereof was adjusted to prepare toner for a laser printer.

Evaluation of Toner Properties

Scanning Electron Microscope (SEM) images of the obtained toner were taken. 50 SEM images were selected from the SEM images of the toner, and then the circularity of the toner was measured based on the calculation formula below using software Image J software 1.33u (National Institutes of Health, USA) for quantification analysis of image materials.

Calculation Formula

Circularity=4π×(area/periphery²)

The circularity of the toner was in the range of 0-1, and as the circularity approached 1, the shape of the toner particles became more spherical.

In addition, the volume diameter of the toner particles was measured using a Coulter counter (Multisizer 3, Beckman, USA).

### Example 1

316 g of deionized water and 307 g of the copolymer latex comprising styrene, butyl acrylate and methacrylate-polyethylene glycol ethylether methacrylate, which was obtained using the polymerization process of the present invention were added to a 1 L reactor, and agitated at 450 rpm. While the mixture was agitated, 30 g of a pigment dispersion solution prepared by mixing HS-10 and RN-10 at a mixing ratio of 100 parts by weight to 25 parts by weight in a mixed black pigment solution that was dispersed by a reactive surfactant was added dropwize to the reactor. The pH of the solution was adjusted to be 11, and then 30 g of MgCl₂ was added to the mixture and the mixture was heated up to 95° C. After the mixture was reacted at 95° C. for 2 hours, NaCl was added to the mixture. 4 hours after the reaction, the temperature of the resultant was cooled to less than room temperature, and the resultant was filtered to separate toner particles and dry them.

As a result, it was confirmed that the prepared toner had circularity of 0.68, which meant that the toner particles were potato-shaped, and had an average volume diameter of about 5.8 μm.

### Example 2

Toner was prepared in the same manner as in Example 1, except that 30 g of a mixed yellow dispersion solution prepared by mixing HS-10 and RN-10 at a mixing ratio of 100 parts by weight to 100 parts by weight was used as a pigment dispersion solution. The prepared toner had circularity of 0.67, potato-shaped particles and an average volume diameter of about 5.6 μm.

### Example 3

Toner was prepared in the same manner as in Example 1, except that 30 g of a mixed magenta dispersion solution prepared by mixing HS-10 and RN-10 at a mixing ratio of 100 parts by weight to 100 parts by weight was used as a pigment dispersion solution. The prepared toner had circularity of 0.54, potato-shaped particles or amorphous-shaped particles and an average volume diameter of about 5.4 μm.

### Example 4

Toner was prepared in the same manner as in Example 1, except that 30 g of a mixed cyan dispersion solution prepared by mixing HS-10 and RN-10 at a mixing ratio of 100 parts by weight to 25 parts by weight was used as a pigment dispersion solution. The prepared toner had circularity of 0.7, potato-shaped particles and an average volume diameter of about 6.0 μm.

### Example 5

Toner was prepared in the same manner as in Example 1, except that 30 g of a mixed cyan dispersion solution prepared by mixing HS-10 and RN-10 at a mixing ratio of 100 parts by weight to 43 parts by weight was used as a pigment dispersion solution. The prepared toner had circularity of 0.91, spherical particles and an average volume diameter of about 5.2 μm.

### Comparative Example 1

346 g of a copolymer latex particle comprising styrene, butyl acrylate, and methacrylate that was polymerized in advance using a sodium dodecyl sulfate (SDS) surfactant was added to 307 g of ultra pure water in which 2.0 g of a SDS surfactant was dispersed and stirred. 18.2 g of an aqueous dispersion of pigment particle (Cyan 15:3, solids content of 40%) dispersed by a SDS surfactant and 17 g of a wax dispersion solution dispersed in the SDS surfactant were added to the mixture and mixed. While the mixture was stirred at 350 rpm, an aqueous latex pigment dispersion solution was titrated using 10% of a NaOH buffer to have a pH of 10. 10 g of MgCl₂, which was an inorganic salt, was dissolved in 30 g of ultra pure water. Then the resulting solution was added to the aqueous latex pigment dispersion solution over a 10 minute period, and the temperature of the mixture was increased by 95 [symbol] . The mixture was heated for 7 hours until toner particles having a desired size were obtained. When the toner particles having the desired size were obtained, the reaction was terminated and the resultant was naturally cooled. The obtained toner particles had an average volume diameter of about 6.5 μm.

### Comparative Example 2

Toner was prepared in the same manner as in Example 1, except that 30 g of a black dispersion solution prepared using HS-10 alone was used as a pigment dispersion solution. The prepared toner particles had circularity of 0.73, were spherical or potato-shaped and had an average volume diameter of about 5.4 μm.

### Comparative Example 3

Toner was prepared in the same manner as in Example 1, except that 30 g of a cyan dispersion solution prepared using HS-10 alone was used as a pigment dispersion solution. The prepared toner particles had circularity of 0.58, were amorphous-shaped and had an average volume diameter of about 5.6 μm.

### Comparative Example 4

Toner was prepared in the same manner as in Example 1, except that 30 g of a magenta dispersion solution prepared using HS-10 alone was used as a pigment dispersion solution. The prepared toner particles were amorphous-shaped and had an average volume diameter of about 3.4 μm.

### Comparative Example 5

Toner was prepared in the same manner as in Example 1, except that 30 g of a yellow dispersion solution prepared using HS-10 alone was used as a pigment dispersion solution. The prepared toner particles were amorphous-shaped and had an average volume diameter of about 2.5 μm.

### Comparative Example 6

Toner was prepared in the same manner as in Example 1, except that 30 g of a black dispersion solution prepared using RN-10 alone was used as a pigment dispersion solution. The prepared toner particles were spherical and had an average volume diameter of about 12 μm or more.

### Comparative Example 7

Toner was prepared in the same manner as in Example 1, except that 30 g of an yellow dispersion solution prepared using RN-10 alone was used as a pigment dispersion solution. The prepared toner particles were spherical and had an average volume diameter of about 15 μm or more.

### Comparative Example 8

Toner was prepared in the same manner as in Example 1, except that 30 g of a magenta dispersion solution prepared using RN-10 alone was used as a pigment dispersion solution. The prepared toner particles were spherical and had an average volume diameter of about 15 μm or more.

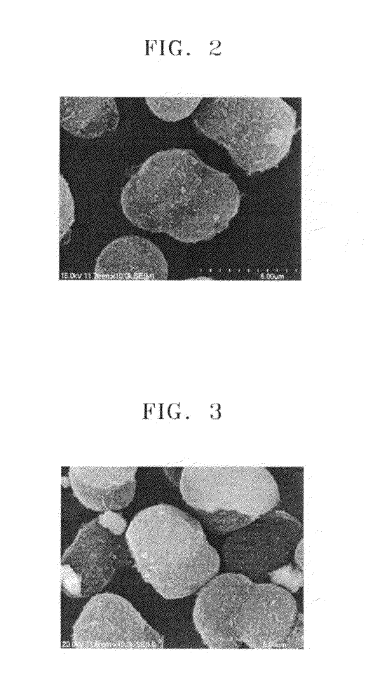

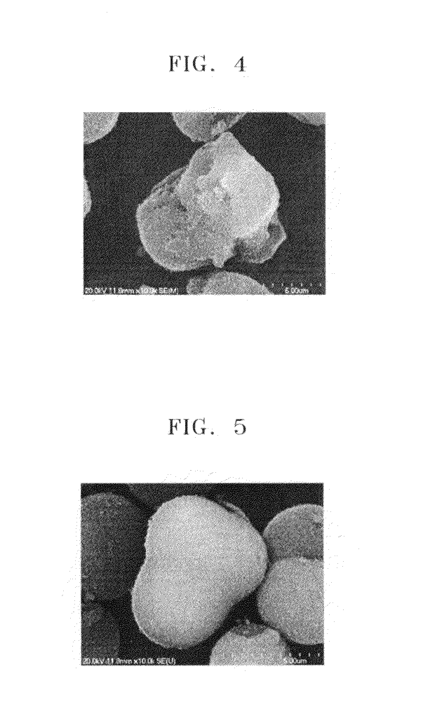

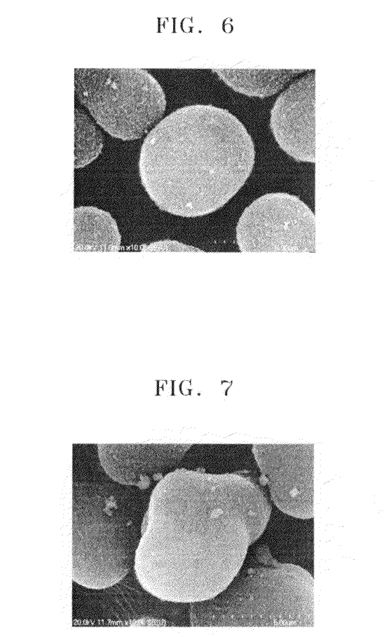

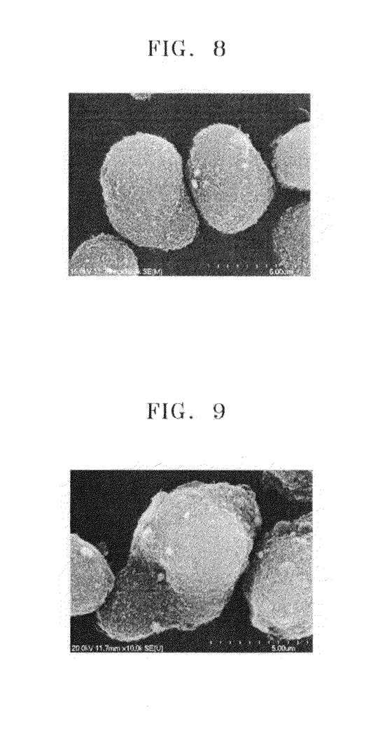

FIGS. 2 through 9 show SEM images of toners prepared in Examples 1 through 5 and Comparative Examples 1 through 3, respectively.

Referring to the examples and drawings, it can be seen that the shape of toner particles after aggregation can be changed according to a mixing ratio of an anionic reactive surfactant and nonionic reactive surfactant when a pigment dispersion solution is prepared. Here, the more spherical the shape of the toner, the better its transferable properties, and the more amorphous the shape of the toner, the better its cleaning properties. Therefore, the shape of toner particles having both good transferable properties and good cleaning properties at the same time can be easily controlled by a mixing ratio of an anionic reactive surfactant and a nonionic reactive surfactant.

According to the present invention, by easily adjusting the shape of the toner particles such that a weight ratio of the anionic reactive surfactant and the nonionic reactive surfactant is controlled, toner for a high-speed printer with high image quality in which fixation of toner particles to paper at a low temperature is possible, and durability and storage are excellent can be obtained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of preparing toner, comprising:
preparing a pigment dispersion solution by dispersing a pigment in a mixed surfactant solution composed of an anionic reactive surfactant and a nonionic reactive surfactant;
mixing the pigment dispersion solution with a polymer latex prepared by polymerizing a toner composition comprising an amphiphilic macromonomer having at least one reactive functional group at an end thereof and at least one polymerizable monomer; and
adding an inorganic salt to a mixed solution of the polymer latex and the pigment dispersion solution to be aggregated,
wherein a shape of toner particles of the toner is controlled to have circularity of 0.5-1.0 by adjusting an amount of the nonionic reactive surfactant to be 20-100 parts by weight based on 100 parts by weight of the anionic reactive surfactant.

2. The method of claim 1, wherein the amphiphilic macromonomer is one selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate.

3. The method of claim 1, wherein the amphiphilic macromonomer of the toner composition has an amount of 1-10 parts by weight based on 100 parts by weight of the polymerizable monomer.

4. The method of claim 1, wherein the amphiphilic macromonomer has a weight average molecular weight of 100-100,000.

5. The method of claim 1, wherein the polymerizable monomer is one selected from vinyl monomer, polar monomer having a carboxyl group, a monomer having an unsaturated polyester group, and a monomer having a fatty acid group.

6. The method of claim 1, wherein the polymerizable monomer is at least one selected from the group consisting of styrene monomers such as styrene, vinyl toluene, α-methyl styrene; acrylic acid, methacrylic acid; derivatives of (meth)acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, metacryl amide; ethylenically unsaturated monoolefins such as ethylene, propylene, butylenes; halogenized vinyls such as vinyl chloride, vinylidene chloride, vinyl fluoride; vinyl esters such as vinyl acetate, vinyl propionate; vinyl ethers such as vinyl methyl ether, vinyl ethyl ether; vinyl ketones such as vinyl methyl ketone, methyl isoprophenyl ketone; and nitrogen-containing vinyl compounds such as 2-vinylpyridine, 4-vinylpyridine, N-vinyl pyrrolidone.

7. The method of claim 1, wherein the anionic reactive surfactant is at least one selected from the group consisting of rosin acid soap, sodium dodecyl sulfate, sodium lauryl sulfate, sodium oleate, potassium oleate, sodium dodecyl benzene sulfonate, sodium dodecyl allyl sulfosuccinate, disodium ethoxylated alcohol half ester of sulfosuccinis acid, sodium dioctyl sulfosuccinate and proprietary sulfosuccinate blend.

8. The method of claim 1, wherein the nonionic reactive surfactant is at least one selected from the group consisting of alkyl polyethoxy acrylate, alkyl polyethoxy methacrylate, aryl polyethoxy acrylate and aryl polyethoxy methacrylate.

9. The method of claim 1, wherein the pigment is one selected from the group consisting of yellow, magenta, cyan and black pigment.

10. The method of claim 1, wherein the amount of the pigment is 10-30 parts by weight based on 100 parts by weight of the mixed surfactant solution.

11. The method of claim 1, wherein the amount of the pigment is 0.1-20 parts by weight based on 100 parts by weight of the polymerizable monomer.

12. The method of claim 1, wherein the pigment dispersion solution is prepared by dispersing a pigment in the anionic reactive surfactant and the nonionic reactive surfactant, respectively and then mixing the anionic reactive surfactant comprising the pigment dispersed therein and the nonionic reactive surfactant comprising the pigment dispersed therein.

13. The method of claim 1, wherein the pigment dispersion solution is prepared by mixing the anionic reactive surfactant and the nonionic reactive surfactant and then dispersing a pigment in the mixed reactive surfactant.

14. The method of claim 1, wherein the toner further comprises at least one selected from the group consisting of an initiator, a chain transfer agent, a charge control agent and a release agent.

15. The method of claim 1, wherein the inorganic salt is at least one selected from the group consisting of NaCl, MgCl₂.8H₂O and [Al₂(OH)ₙCl₆₋ₙ]ₘ where 1≦n≦5, 1≦m≦10.

16. A developing unit containing toner prepared using a method of:
preparing a pigment dispersion solution by dispersing a pigment in a mixed surfactant solution composed of an anionic reactive surfactant and a nonionic reactive surfactant;
mixing the pigment dispersion solution with a polymer latex prepared by polymerizing a toner composition comprising an amphiphilic macromonomer having at least one reactive functional group at an end thereof and at least one polymerizable monomer; and
adding an inorganic salt to a mixed solution of the polymer latex and the pigment dispersion solution to be aggregated,
wherein a shape of toner particles of the toner is controlled to have circularity of 0.5-1.0 by adjusting an amount of the nonionic reactive surfactant to be 20-100 parts by weight based on 100 parts by weight of the anionic reactive surfactant.

17. Toner prepared by a method of:
preparing a pigment dispersion solution by dispersing a pigment in a mixed surfactant solution composed of an anionic reactive surfactant and a nonionic reactive surfactant;
mixing the pigment dispersion solution with a polymer latex prepared by polymerizing a toner composition comprising an amphiphilic macromonomer having at least one reactive functional group at an end thereof and at least one polymerizable monomer; and
adding an inorganic salt to a mixed solution of the polymer latex and the pigment dispersion solution to be agglomerated,
wherein particles of the toner can have circularity of 0.5-1.0 by adjusting the amount of the nonionic reactive surfactant to be 20-100 parts by weight based on 100 parts by weight of the anionic reactive surfactant.

18. The toner of claim 17, wherein the anionic reactive surfactant is at least one selected from the group consisting of rosin acid soap, sodium lauryl sulfate, sodium oleate, potassium oleate, sodium dodecyl benzene sulfonate, sodium dodecyl allyl sulfosuccinate, disodium ethoxylated alcohol half ester of sulfosuccinis acid, sodium dioctyl sulfosuccinate and proprietary sulfosuccinate blend.

19. The toner of claim 17, wherein the nonionic reactive surfactant is at least one selected from the group consisting of alkyl polyethoxy acrylate, alkyl polyethoxy methacrylate, aryl polyethoxy acrylate and aryl polyethoxy methacrylate.

20. The toner of claim 17, wherein the amphiphilic macromonomer is one selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate.

21. A method of forming an image using toner in an image forming apparatus, the toner prepared by:
preparing a pigment dispersion solution by dispersing a pigment in a mixed surfactant solution composed of an anionic reactive surfactant and a nonionic reactive surfactant;
mixing the pigment dispersion solution with a polymer latex prepared by polymerizing a toner composition comprising an amphiphilic macromonomer having at least one reactive functional group at an end thereof and at least one polymerizable monomer; and
adding an inorganic salt to a mixed solution of the polymer latex and the pigment dispersion solution to be aggregated,
wherein a shape of toner particles of the toner is controlled to have circularity of 0.5-1.0 by adjusting an amount of the nonionic reactive surfactant to be 20-100 parts by weight based on 100 parts by weight of the anionic reactive surfactant,
wherein the method comprises attaching the toner to the surface of a photoreceptor on which an electrostatic latent image is formed to form a visualized image and transferring the visualized image to a transfer medium.

22. An image forming apparatus comprising:
an organic photoreceptor;
an image forming unit that forms an electrostatic latent image on a surface of the organic photoreceptor;
an unit to receive the toner prepared using a method of:
preparing a pigment dispersion solution by dispersing a pigment in a mixed surfactant solution composed of an anionic reactive surfactant and a nonionic reactive surfactant,
mixing the pigment dispersion solution with a polymer latex prepared by polymerizing a toner composition comprising an amphiphilic macromonomer having at least one reactive functional group at an end thereof and at least one polymerizable monomer, and
adding an inorganic salt to a mixed solution of the polymer latex and the pigment dispersion solution to be aggregated,
wherein a shape of toner particles of the toner is controlled to have circularity of 0.5-1.0 by adjusting an amount of the nonionic reactive surfactant to be 20-100 parts by weight based on 100 parts by weight of the anionic reactive surfactant;
a toner supplying unit that supplies the toner of the unit onto the surface of the organic photoreceptor in order to form a toner image by developing the electrostatic latent image; and
a toner transferring unit that transfers the toner image to a transfer medium from the surface of the organic photoreceptor.
